(19) United States
(12) Patent Application Publication
(10) Pub. No.: US 2022/0088783 A1
(43) Pub. Date: Mar. 24, 2022

(54) Method and Apparatus for Manufacturing Line Simulation

(71) Applicant: ABB Schweiz AG, Baden (CH)

(72) Inventors: Wenyao Shao, Shanghai (CN); Shaojie Cheng, Shanghai (CN); Jiajing Tan, Shanghai (CN)

(73) Assignee: ABB Schweiz AG, Baden (CH)

(21) Appl. No.: 17/419,486

(22) PCT Filed: Jan. 21, 2019
(86) PCT No.: PCT/CN2019/072563

§ 371 Date: Jun. 29, 2021

(51) Int. Cl. B25J 9/16; G06T 7/70; G05B 19/418; B25J 9/00

(52) U.S. Cl. CPC B25J 9/1671; G06T 7/70; G05B 2219/32357; B25J 9/0093; G05B 2219/40091; G05B 19/41885

(57) ABSTRACT

Methods for simulating an object in a manufacturing line, wherein the object is placed on a conveyor in the manufacturing line. In the method, a position of the object is obtained from object data collected by a camera device deployed in the manufacturing line. A movement of the conveyor is determined from a controller of the conveyor. An object position of the object is obtained based on the determined position and an offset of the object caused by the movement of the conveyor. A virtual representation of the object is displayed at the determined object position in a virtual environment. With the virtual environment, the administrator of the manufacturing line may be provided with accurate states of the manufacturing line, based on which operations of a robot system that is to be deployed in the manufacturing line may be estimated.

### FIELD

Example embodiments of the present disclosure generally relate to manufacturing line management, and more specifically, to methods, apparatuses, systems, and computer readable media for simulating object(s) in a manufacturing line.

### BACKGROUND

With developments of computer and automatic control, robot systems have been widely used to process various types of objects in the manufacturing industry. Due to the high performance of the robot system, human workers may be replaced by the robot system. Before the robot system is actually purchased and deployed in the manufacturing line, managers, designers or other administrators of the manufacturing line usually expect to know which type of robot system may work well with the objects that are carried on a conveyor in the existing manufacturing line. Although there have been proposed several solutions for simulating states of the manufacturing line, these solutions cannot reflect the accurate states of the existing manufacturing line.

### SUMMARY

Example embodiments of the present disclosure provide solutions simulating at least one object in a manufacturing line.

In a first aspect, example embodiments of the present disclosure provide a method for simulating at least one object in a manufacturing line, here the at least one object is placed on a conveyor in the manufacturing line. The method comprises: obtaining a position of one of the at least one object from object data collected by a camera device deployed in the manufacturing line; determining a movement of the conveyor from a controller of the conveyor; obtaining an object position of the object based on the determined position and an offset of the object caused by the movement of the conveyor; and displaying a virtual representation of the object at the determined object position in a virtual environment. With these embodiments, the position of the object placed on a conveyor in a real manufacturing line may be obtained, and an online simulation mode is provided for displaying the virtual representation of the object during operations of the manufacturing line. Based on the obtained position, the virtual representation of the object may be displayed in a virtual environment to the administrator of the manufacturing line. With the virtual environment, the administrator may estimate operations of a robot system that is to be deployed in the manufacturing line and know whether the to-be-deployed robot system may work well with the existing manufacturing line in advance. Further, the virtual environment may facilitate the administrator to select an appropriate robot system.

In some embodiments of the present disclosure, determining the offset of the object comprises: determining a first time point at which the object data is collected by the camera device; determining a second time point for displaying the virtual representation of the object; and determining the offset based on a velocity of the movement of the conveyor and a time difference between the determined first and second time points. In the manufacturing line, the movement of the conveyor is usually fast and the object carried on the conveyor may move a non-negligible distance within the time duration from obtaining the object data and displaying the virtual representation of the object. With these embodiments, the movement of the conveyor may be considered, and therefore the virtual representation of the object may be displayed at an accurate position that is synchronized with the real position in the existing manufacturing line, such that the administrator of the manufacturing line may be facilitated in taking corresponding actions.

In some embodiments of the present disclosure, the method further comprises: adjusting the velocity of movement of the conveyor; and displaying the virtual representation of the object comprises: displaying the virtual representation of the object based on the adjusted velocity. With these embodiments, the states of the conveyor may be adjusted. For example, the velocity of the movement may be increased to estimate the performance of the to-be-deployed robot system when the conveyor moves at an adjustable velocity. The displayed virtual representations may facilitate the administrator to discover potential abnormal state of the conveyor and whether a disharmony occurs between the to-be-deployed robot system and the existing conveyor.

In some embodiments of the present disclosure, besides the above online mode, an offline simulation mode is provided. The method further comprises: generating a position sequence based on object positions that are obtained during a predefined time duration, an object position comprised in the position sequence being associated with a time point within the predefined time duration. With these embodiments, the object position may be saved in the position sequence for offline simulation at any later time. Further, the simulated states of the manufacturing line may be adjusted by changing parameters in the position sequence, therefore a much flexible simulating solution may be provided.

In some embodiments of the present disclosure, the virtual representation of the object may be displayed according to various criteria: a time criterion and a position criterion. According to the time criterion, the virtual representation of the object may be displayed at a time point associated with the obtained object position. According to the position criterion, the virtual representation of the object may be displayed if a virtual representation of the conveyor reaches a position corresponding to the obtained object position. With these embodiments, the virtual representations of the object may be displayed in a flexible way.

In some embodiments of the present disclosure, the method further comprises: determining an action of a robot system for processing the object, the robot system is to be deployed in the manufacturing line; and displaying a virtual representation of the robot system based on the determined action. With these embodiments, the displayed virtual representation of the object and the action of the robot system may facilitate the administrator to determine whether the robot system work well with the existing manufacturing line, such that potential abnormal state of the conveyor and a disharmony between the robot system and the conveyor may be easily detected.

In some embodiments of the present disclosure, determining the action of the robot system comprises: determining the action based on a processing pattern defining a manner for processing an object by the robot system. Depending on a type and other configurations of the robot system, the robot system may perform various actions. With these embodiments, the processing pattern provides more flexibility for simulating operations of the robot system and allows the administrator to estimate potential risks after the robot system is deployed in the manufacturing line.

In some embodiments of the present disclosure, the camera device comprises a distance measurement camera, and the object data comprises a distance between the object and the camera device; and determining the position comprises: determining the position based on the distance and a position of the camera device. With these embodiments, the distance between the object and the camera device may be accurately measured by a distance measurement sensor in the distance measurement camera.

In some embodiments of the present disclosure, the camera device comprises an image camera, and the object data comprises an image collected by the camera device, and determining the position comprises: determining the position based on a position of the camera device and an image processing of the collect image. 3D cameras are equipped with the distance measurement sensor, while 2D cameras usually only provide the function for capturing images. These embodiments provide solutions for determining the object position based on an image processing of the collect image, therefore cheaper 2D cameras may be utilized for determining the object position.

In a second aspect, example embodiments of the present disclosure provide an apparatus for simulating at least one object in a manufacturing line, here the at least one object is placed on a conveyor in the manufacturing line. The apparatus comprises: a position obtaining unit configured to obtain a position of one of the at least one object from object data collected by a camera device deployed in the manufacturing line; a movement determining unit configured to determine a movement of the conveyor from a controller of the conveyor; an object position obtaining unit configured to obtain an object position of the object based on the determined position and an offset of the object caused by the movement of the conveyor; and a displaying unit configured to display a virtual representation of the object at the determined object position in a virtual environment.

In some embodiments of the present disclosure, the apparatus further comprises: a determining unit configured to determine the offset of the object. The determining unit comprises: a first time unit configured to determine a first time point at which the object data is collected by the camera device; a second time unit configured to determine a second time point for displaying the virtual representation of the object; and an offset determining unit configured to determine the offset based on a velocity of the movement of the conveyor and a time difference between the determined first and second time points.

In some embodiments of the present disclosure, the apparatus further comprises: an adjusting unit configured to adjust the velocity of movement of the conveyor; and the displaying unit is further configured to display the virtual representation of the object based on the adjusted velocity.

In some embodiments of the present disclosure, the apparatus further comprises: a generating unit configured to generate a position sequence based on object positions that are obtained during a predefined time duration, an object position comprised in the position sequence being associated with a time point within the predefined time duration.

In some embodiments of the present disclosure, the apparatus further comprises: an offline displaying unit configured to display, in the virtual environment, a virtual representation of the object in response to a virtual representation of the conveyor reaching a position corresponding to an object position in the position sequence.

In some embodiments of the present disclosure, the apparatus further comprises: an offline displaying unit configured to display, in the virtual environment, a virtual representation of the object at a time point associated with an object position in the position sequence.

In some embodiments of the present disclosure, the apparatus further comprises: an action determining unit configured to determine an action of a robot system for processing the object, the robot system is to be deployed in the manufacturing line; and the displaying unit is further configured to display a virtual representation of the robot system based on the determined action.

In some embodiments of the present disclosure, the action determining unit is further configured to determine the action based on a processing pattern defining a manner for processing an object by the robot system.

In some embodiments of the present disclosure, the camera device comprises a distance measurement camera, and the object data comprises a distance between the object and the camera device; and the position determining unit is further configured to determine the position based on the distance and a position of the camera device.

In some embodiments of the present disclosure, the camera device comprises an image camera, and the object data comprises an image collected by the camera device, and the position determining unit is further configured to determine the position based on a position of the camera device and an image processing of the collect image.

In a third aspect, example embodiments of the present disclosure provide a system for simulating the at least one object in a manufacturing line. The system comprises: a computer processor coupled to a computer-readable memory unit, the memory unit comprising instructions that when executed by the computer processor implements the method for simulating the at least one object in the manufacturing line according to a first aspect of the present disclosure.

In a fourth aspect, example embodiments of the present disclosure provide a computer readable medium having instructions stored thereon, the instructions, when executed on at least one processor, cause the at least one processor to perform the method for simulating the at least one object in the manufacturing line according to a first aspect of the present disclosure.

In a fifth aspect, example embodiments of the present disclosure provide a manufacturing system. The manufacturing system comprises: a manufacturing line, comprising: a conveyor; and a camera device configured to collect object data of at least one object placed on the conveyor; an apparatus for simulating the at least one object in the manufacturing line according to a second aspect of the present disclosure.

### DESCRIPTION OF DRAWINGS

FIG. 1 illustrates a schematic diagram of a manufacturing line that comprises a conveyor for carrying at least one object that is to be processed by a worker;

FIG. 2 illustrates a schematic diagram for simulating at least one object in a manufacturing line in according with embodiments of the present disclosure;

FIG. 3 illustrates a flowchart of a method for simulating at least one object in a manufacturing line in accordance with embodiments of the present disclosure;

FIG. 4 illustrates a schematic diagram for obtaining an object position in accordance with embodiments of the present disclosure;

FIG. 5 illustrates a schematic diagram for obtaining an object position in accordance with embodiments of the present disclosure;

FIG. 6 illustrates a schematic diagram for determining an object position of an object that is carried on a conveyor in accordance with embodiments of the present disclosure;

FIG. 7 illustrates a schematic diagram for determining an object position of an object based on an adjusted velocity of a conveyor in accordance with embodiments of the present disclosure;

FIG. 8 illustrates a schematic diagram of an apparatus for simulating at least one object in a manufacturing line in accordance with embodiments of the present disclosure; and

FIG. 9 illustrates a schematic diagram of a system for simulating at least one object in a manufacturing line in accordance with embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

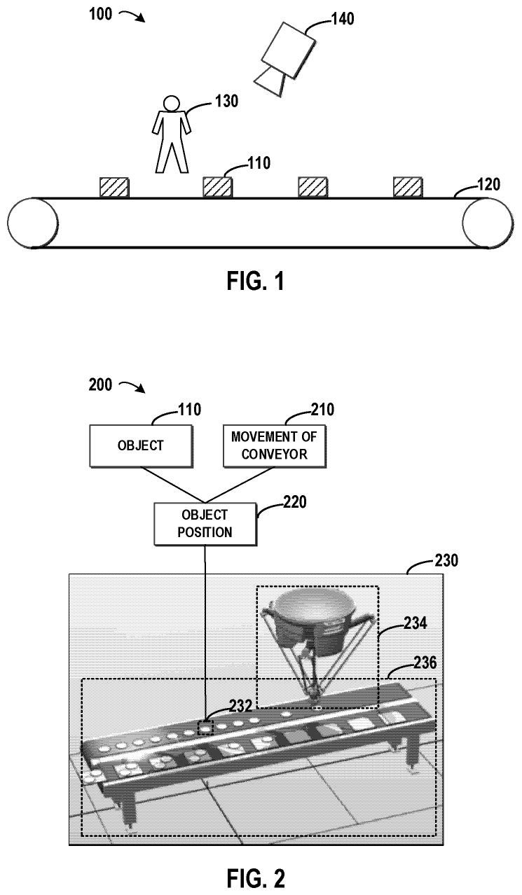

For the sake of description, reference will be made to FIG. 1 to provide a general description of environment of a manufacturing line. FIG. 1 illustrates a schematic diagram of a manufacturing line 100. In FIG. 1, the manufacturing line 100 may comprise a conveyor 120, on which at least one object 110 is placed. Here, the at least one object 110 may be processed by a human worker 130. For example, in a line for packaging bottles into boxes, the worker 130 may pick up the bottles carried on the conveyor 120 and put them into target boxes.

With developments of the robot technique, robot systems may be widely used in various manufacturing lines to replace human workers. For example, the robot system may perform various actions to the objects (such as grabbing the object, measuring the size of the object, cutting the object to a predetermined shape, etc.). In order to select an appropriate robot system to replace the human worker 130, the administrator usually needs to consider various parameters for both the manufacturing line 100 and candidate robot systems, and then the selected robot system may be deployed in the manufacturing line 100.

In order to help the administrator to make a decision, several solutions are proposed to simulating the objects 110 on the conveyor 120. Here, positions of the objects 110 are estimated by human experience. In these solutions, multiple objects may be placed at positions with a fixed interval (such as an interval of 10 centimeters or another value). However, there may be different spacing between the points of objects in the real manufacturing line. For example, the interval between some objects may be 9.5 cm, while the interval between other objects may be 10.5 cm. Therefore the simulated object positions cannot reflect accurate states for objects in the real manufacturing line.

In order to at least partially solve the above and other potential problems, a new method is disclosed according to embodiments of the present disclosure. Specifically, the method may simulate at least one object being placed on a conveyor in a manufacturing line. In general, according to embodiments of the present disclosure, a camera device 140 may be deployed in the manufacturing line 100. Here, the camera device 140 may collect object data related to the object 110 for obtaining a position of the object 110. Further, a movement of the conveyor 120 may be determined from a controller of the conveyor 120. An object position of the object 110 may be obtained based on the determined position and an offset of the object 110 caused by the movement of the conveyor 120. Therefore, a virtual representation of the object 110 may be displayed at the determined object position in a virtual environment.

In these embodiments, the position of the object 110, the movement of the conveyor 120, and the object position may be represented by respective local coordinate systems. In order to provide the virtual representation, those local coordinate systems may be converted into the world coordinate system via corresponding converting matrixes.

Reference will be made to FIG. 2 for more details about the simulation. FIG. 2 illustrates a schematic diagram 200 for simulating the at least one object 110 placed on the conveyor 120 in according with embodiments of the present disclosure. As shown in FIG. 2, the object position 220 of the object 110 may be determined based on the relative position of the object 110 with the conveyor 120 and the movement 210 of the conveyor 120. For the sake of simplicity, the virtual representation of the object 110 may be referred to as a virtual object 232. Here, a virtual environment 230 may be provided for displaying the virtual object 232 at the objection position 220. As the object position 220 may be continuously obtained, a continuous display of the virtual environment 230 for simulating the at least one object 110 may be provided to the administrator.

Based on the virtual environment 230, the administrator may estimate operations of a robot system that is to be deployed in the manufacturing line 100 and know whether the to-be-deployed robot system may work well with the existing manufacturing line 100 in advance. Further, the virtual environment 230 may facilitate the administrator to select an appropriate robot system. Although the selected robot system is not really deployed in the manufacturing line 100, operations of the robot system may be estimated by displaying 3D virtual models of the robot system and object.

In some embodiments, in addition to displaying the virtual object 232, a virtual representation of the conveyor 120 (also referred to as a virtual conveyor 236) and a virtual representation of the to-be-deployed robot system (also referred to as a virtual system 234) may be displayed in the virtual environment 230. Therefore, the virtual environment 230 may provide a full picture for simulating operations of the manufacture line 100 after the robot system is deployed.

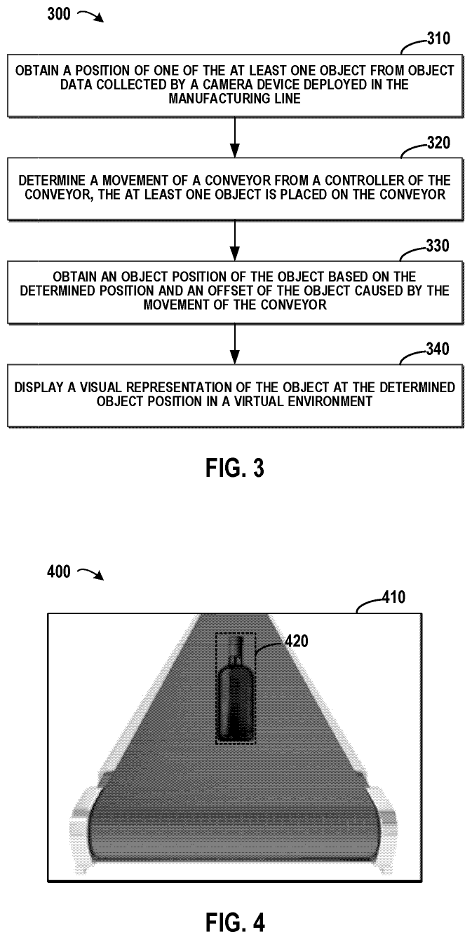

Details of the present invention will be provided with reference to FIG. 3, which illustrates a flowchart of a method 300 for simulating the at least one object 110 in accordance with embodiments of the present disclosure. At a block of 310, a position of one of the at least one object 110 may be obtained from object data collected by the camera device 140 deployed in the manufacturing line 100. Embodiments of the present disclosure provide multiple simulation modes, where an online mode may provide real time simulation by obtaining the object position from object data collected from the camera device 140, and an offline mode may provide offsite simulation by obtaining the object position from a file including object positions that are obtained previously. Hereinafter, details about the online mode will be described first.

In some embodiments of the present disclosure, the camera device 140 may be deployed in the manufacturing line 100 for collecting the object data. In these embodiments, the camera device 140 may be deployed near the object 110 for capturing images of the object 110. In addition to and/or alternatively, images collected by an existing camera device (which has already been deployed in the manufacturing line 100 for other purpose) may be used to determine the object position 220.

Various types of camera devices 140 may be selected in these embodiments. It is to be understood that, beside the common function for capturing images, 3D cameras may be equipped with a distance measurement sensor. With this sensor, a distance between the camera and the object may be directly measured. However, for 2D cameras such as ordinary cameras, they can only capture images, and thus the images should be processed for determining the position of the object 110.

Reference will be made to FIG. 4 for describing how to determine the object position 220 of the object 110 by using an ordinary camera. FIG. 4 illustrates a schematic diagram 400 for obtaining the object position 220 from an image 410 captured by an ordinary camera in accordance with embodiments of the present disclosure. In FIG. 4, an image 410 may be captured by the ordinary camera, and the image 410 may include an object 420 carried on the conveyor 120. Based on an image recognition technology, the object 420 may be identified from the image 410. Various methods may be utilized for identifying the object 420, for example, a reference image of the to-be-identified object may be provided in advance. By comparing the reference image with the image 410, the area which includes the object 420 may be identified from the image 410. As shown in FIG. 4, if the manufacturing line 100 is for packaging bottle(s) carried on the conveyor 150 into a box, then the reference image may be an image of the bottle.

Once the object 420 is identified from the image 410, the distance between the object 420 and the camera may be determined. For example, the number of pixels within the area of the object 420 and the number of pixels of the image 410 may be used to determine the distance. Alternatively, more complicated algorithms may be utilized to determine the distance. With the distance of between the object 420 and the camera device 140, the object position 220 may be determined. These embodiments provide solutions for determining the object position 220 based on an image processing of the collected image 410, therefore ordinary and cheaper cameras may be utilized for determining the object position 220. It is to be understood that, although the above paragraphs describe multiple positions that may be represented in different coordinate systems, these positions may be converted into a world coordinate system based on respective converting matrixes.

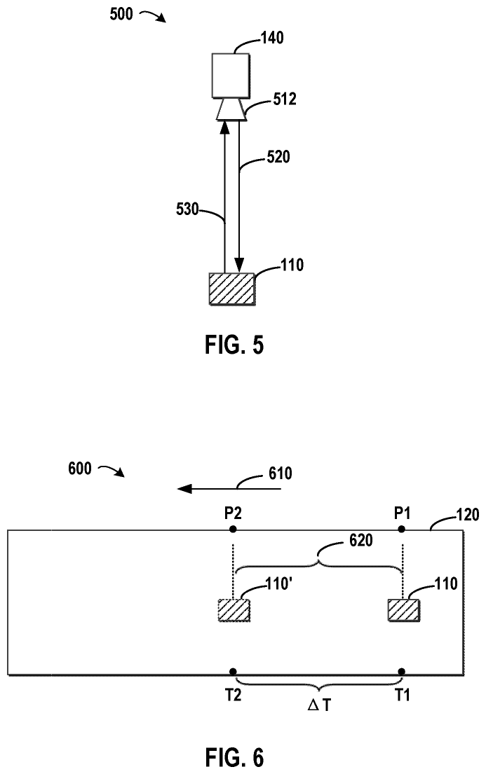

In some embodiments of the present disclosure, a 3D camera equipped with a distance measure sensor may be utilized for determining the object position 220, and reference will be made to FIG. 5 for description. FIG. 5 illustrates a schematic diagram 500 for obtaining the object position 220 by a distance measurement sensor 512 equipped in the camera device 140. As shown in FIG. 5, the camera device 140 may include the distance measurement sensor 511. During operations of the camera device 140, the sensor 512 may transmit a signal 520 (such as a laser beam) towards the object 110. The signal 520 may reach the object 110 and then a signal 530 may be reflected by the object 110. The sensor 512 may receive the reflected signal 530 and determine the distance between the camera device 140 and the object 110 based on a time duration between time points for transmitting the signal 520 and receiving the signal 530.

With these embodiments, the distance between the object 110 and the camera device 140 may be accurately measured by the distance measurement sensor 512. As the distance measurement sensor 512 increases the cost of the camera device 512, these embodiments are more suitable for precision manufacture lines with high requirements for simulation accuracy.

Usually, in the manufacturing line 100, the movement of the conveyor 120 is fast and the object 110 carried on the conveyor 120 may pass a non-negligible distance within the time duration from obtaining the image of the object 110 and displaying the virtual object 232. Referring back to FIG.3, at a block 320, a movement of the conveyor 120 may be determined from a controller of the conveyor 120. As the object 110 may move along with the conveyor 120, a velocity of the object 110 is equal to the velocity of movement of the conveyor 120.

At a block 330, the object position of the object 110 may be determined based on the position (as determined in the block 310) and an offset of the object caused by the movement of the conveyor 120. With these embodiments, the object position 220 may be determined according to the movement of the conveyor 120, therefore the accurate state of the object 110 may be displayed, and the administrator of the manufacturing line 100 may take corresponding behaviors for control.

In some embodiments of the present disclosure, the offset may be determined based on the velocity of the conveyor 120 and the time period when the object 110 is placed on the conveyor 120. Accordingly, a first time point at which the object data is collected by the camera device 140 may be determined. During operations of the camera device 140, a timestamp may be generated to indicate the time point when the image is captured. Then, the image may be processed to determine the position when the image is captured. It is to be understood that the conveyor 120 may move a distance before the virtual object 232 is displayed in the virtual environment 230. According, a second time point for displaying the virtual object 232 of the object 110 may be determined to estimate how long the object 110 moves along with the conveyor 120 in the real environment.

Further, based on a time difference between the first and second time points and the velocity, the distance of the movement of the object 110 may be determined. With these embodiments, the movement of the conveyor 120 is considered in the simulation, and the virtual object 232 may be displayed at an accurate position that is synchronized with the real position in the real environment. Accordingly, the administrator may know the accurate states of the object 110, therefore further control to the robot system may be implemented on a reliable base.

Although the conveyor 120 is shown in a line shape, the conveyor 120 may show other shapes such as a round conveyor, an ellipse shape or an irregular shape. At this point, the velocity may be represented in a vector format indicating respective components in x, y and z directions.

Reference will be made to FIG. 6 for details about how to determine the object position 220. As shown in FIG. 6, the object 110 is placed on the conveyor 120. At a time point T1, the object 110 is located at a position P1. As the conveyor 120 is moving from the right to the left (as shown by an arrow 610) at a velocity V, the object 110 will reach a position P2 between the time points T1 and T2 (at which time point the virtual object 232 will be displayed in the virtual environment 230). Based on the geometry relationship shown in FIG. 6, the object 110 will move a distance 620, and the distance 620 may be determined as V*(T2−T1). Therefore, the object position 220 may be determined as:

P2=P1+V*(T2−T1) Equation 1

Based on the above Equation 1, the object position 220 may be determined for each position P1 that is obtained from each image taken by the camera device 140.

Referring back to FIG. 3, at a block 340, the virtual object 232 may be displayed in the virtual environment 230 at the object position as determined at the block 330. As the object position may be obtained continuously, an animation indicating the movement of the virtual object 232 along with the virtual conveyor 236 may be displayed in the virtual environment 230.

In some embodiments of the present disclosure, the velocity of movement of the conveyor 120 may be adjusted, and the simulation may be based on the adjusted velocity. In one example, in the real environment, due to the limited performance of human workers, the velocity of the conveyor 120 is restrained to 1 meter/second. The to-be-deployed robot system may greatly increase the performance of the manufacturing line 100. At this point, it is desired to see the operations of the manufacturing line when the velocity of the conveyor 120 is increased to a greater value (such as 2 meters/second). In this situation, the movement of the virtual conveyor 236 and the virtual object 232 may be faster than that of the conveyor 120 and the object 110 in the real environment. With these embodiments, the displayed virtual representations may simulate various operations of the robot system under various situations, and thus facilitate the administrator to discover potential abnormal state of the conveyor and a disharmony between the to-be-deployed robot system and the existing conveyor.

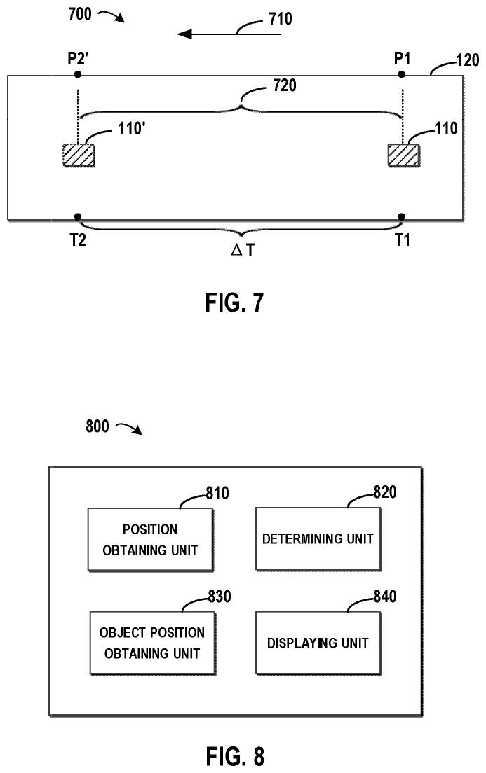

Reference will be made to FIG. 7 for describing how to display the virtual object 232 based on the adjusted velocity. FIG. 7 illustrates a schematic diagram 700 for determining an object position of an object based on an adjusted velocity of a conveyor in accordance with embodiments of the present disclosure. As shown in FIG. 7, at a time point T1, the object 110 is located at a position P1. As the conveyor 120 is moving from the right to the left (as shown by an arrow 710) at a faster velocity V′, the object 110 will reach a position P2′ between the time points T1 and T2. Here, the object 110 will move a distance 720, and the distance 720 may be determined as V′*(T2−T1). Therefore, the object position 220 may be determined as:

P2′=P1+V′*(T2−T1) Equation 2

The above paragraphs have described embodiments of the online simulation, where the virtual object 232 is directly displayed in the virtual environment 230 as the camera device 140 collects object data. While in the offline mode, the object position may be stored into a position sequence for further purpose. When the position sequence is loaded for offline simulation, the virtual object 232 may be displayed at the object position in the position sequence.

In some embodiments of the present disclosure, a position sequence may be generated based on object positions that are obtained during a previous time duration. For example, the camera device 140 may continuously collect object data for 1 minute. Based on the object positions of the object 110 and the corresponding time points during the time duration, the position sequence may be generated. With these embodiments, the object position may be collected in advance instead of in real time. Further, the states of the manufacturing line 100 may be adjusted according to various parameters to simulate operations of the robot system under various states of the manufacturing line, therefore a much flexible simulating solution may be provided.

In the offline mode, the object positions in the position sequence may be determined in a similar way as that of the online mode. Various data structures may be used for storing the position sequence of the object 110. Hereinafter, Table 1 shows an example data structure for the position sequence.

TABLE 1
Example Position Sequence

| No. | Object Position | Time Point |
|---|---|---|
| 0 | (x0, y0, z0) | T0 |
| 1 | (x1, y1, z1) | T1 |
| 2 | (x2, y2, z2) | T2 |
| . . . | . . . | . . . |

In the above Table 1, the first column represents a serial number of the position, the second column represents a position of the object, and the third column represents a time point for displaying the virtual object 232 in the virtual environment 230. It is to be understood that the above Table 1 is only an example data structure for storing the position sequence. In other embodiments, other data structures may be adopted. For example, a time interval may be defined and thus the third column for indicating the time points may be omitted.

In some embodiments of the present disclosure, the virtual object 232 may be displayed according to various criteria: a time criterion and a position criterion.

According to the time criterion, the virtual object 232 may be displayed at a time point associated with the obtained object position 220. Referring the above example of Table 1, when the position sequence as shown in Table 1 is loaded in the offline mode, the virtual object 232 may be displayed in the position (x1, y1, z1) at a time position corresponding to T1 according to the time criterion. Here, the time point for starting the simulation may be represented as t0, and the time line of the simulation may be aligned to T0 in the position sequence. During the offline simulation, the virtual object 232 may be displayed at a time point tl corresponding to T1 (where t1=T1−T0). Based on a similar manner, the virtual object 232 may be displayed in the position (x2, y2, z2) at a time position t2 corresponding to T2.

According to the position criterion, the virtual object 232 may be displayed when the virtual conveyor 236 reaches a position corresponding to the obtained object position 220. Referring the above example of Table 1, when the position sequence as shown in Table 1 is loaded in the offline mode, the virtual object 232 may be displayed at the position (x0, y0, z0) when the virtual conveyor reaches the position (x0, y0, z0).

In some embodiments of the present disclosure, the virtual conveyor 236 of the conveyor 120 may be displayed in the virtual environment 230 based on the velocity of the movement of the conveyor 120. In the virtual environment 230, the virtual conveyor 236 may move with the rotation of driving shafts of the conveyor 120, and the virtual object 232 placed on the virtual conveyor 236 may move along with the virtual conveyor 236. With these embodiments, the states of the conveyor 120 are also displayed in the virtual environment 230, such that the administrator may see a whole picture of each component associated with the manufacturing line 100. Moreover, the displayed virtual representations may facilitate the administrator to discover potential abnormal states of the conveyor 120 and a disharmony between the robot system and the conveyor 120.

In some embodiments of the present disclosure, an action of the to-be-deployed robot system for processing the object may be determined, and then the virtual representation of the robot system may be determined based on the determined action. The action may depend on the purpose of the robot system. In a packaging line for packaging bottles into boxes, the action may relate to picking up the bottles and putting them into the target boxes. In a manufacturing line for cutting the object 110 into a desired shape, the action 222 may relate to a predefined robot path for cutting the object 110.

In some embodiments of the present disclosure, the action may be determined based on a processing pattern defining a manner for processing an object by the robot system. Based on functions of the robot system, various processing patterns may be defined for the robot system. In one example, the processing pattern may define a destination position to which the robot system 120 places the object 130. In a manufacturing line for packaging bottles on the conveyor 150 into boxes, the destination position may be a location of the box. Further, the processing pattern may define how to package the bottles. In one example, it may define that every six bottles should be packaged into one box. In a manufacturing line for cutting raw workpieces into desired shapes, the processing pattern may define a path of the robot system 120 or other parameters for controlling the robot system. With these embodiments, the processing pattern provides more flexibility for controlling the robot system. Accordingly, the virtual environment 230 may simulate corresponding actions of the robot system even if the robot system is not really deployed in the manufacturing line 100.

In some embodiments of the present disclosure, an apparatus 800 is provided for simulating at least one object in a manufacturing line. FIG. 8 illustrates a schematic diagram of the apparatus 800 for simulating at least one object in a manufacturing line in accordance with embodiments of the present disclosure. As illustrated in FIG. 8, the apparatus 800 may comprise: a position obtaining unit 810 configured to obtain a position of one of the at least one object from object data collected by a camera device deployed in the manufacturing line; a movement determining unit 820 configured to determine a movement of the conveyor from a controller of the conveyor; an object position obtaining unit 830 configured to obtain an object position of the object based on the determined position and an offset of the object caused by the movement of the conveyor; and a displaying unit 840 configured to display a virtual representation of the object at the determined object position in a virtual environment.

In some embodiments of the present disclosure, the apparatus 800 further comprises a determining unit configured to determine the offset of the object. The determining unit comprises: a first time unit configured to determine a first time point at which the object data is collected by the camera device; a second time unit configured to determine a second time point for displaying the virtual representation of the object; and an offset determining unit configured to determine the offset based on a velocity of the movement of the conveyor and a time difference between the determined first and second time points.

In some embodiments of the present disclosure, the apparatus 800 further comprises: an adjusting unit configured to adjust the velocity of movement of the conveyor; and the displaying unit is further configured to display the virtual representation of the object based on the adjusted velocity.

In some embodiments of the present disclosure, the apparatus 800 further comprises: a generating unit configured to generate a position sequence based on object positions that are obtained during a predefined time duration, an object position comprised in the position sequence being associated with a time point within the predefined time duration.

In some embodiments of the present disclosure, the apparatus 800 further comprises: an offline displaying unit configured to display, in the virtual environment, a virtual representation of the object in response to a virtual representation of the conveyor reaching a position corresponding to an object position in the position sequence.

In some embodiments of the present disclosure, the apparatus 800 further comprises: an offline displaying unit configured to display, in the virtual environment, a virtual representation of the object at a time point associated with an object position in the position sequence.

In some embodiments of the present disclosure, the apparatus 800 further comprises: an action determining unit configured to determine an action of a robot system for processing the object, the robot system is to be deployed in the manufacturing line; and the displaying unit is further configured to display a virtual representation of the robot system based on the determined action.

In some embodiments of the present disclosure, the action determining unit is further configured to determine the action based on a processing pattern defining a manner for processing an object by the robot system.

In some embodiments of the present disclosure, the camera device comprises a distance measurement camera, and the object data comprises a distance between the object and the camera device; and the position determining unit is further configured to determine the position based on the distance and a position of the camera device.

In some embodiments of the present disclosure, the camera device comprises an image camera, and the object data comprises an image collected by the camera device, and the position determining unit is further configured to determine the position based on a position of the camera device and an image processing of the collect image.

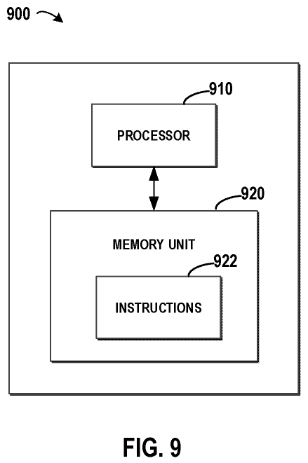

In some embodiments of the present disclosure, a system 900 is provided for simulating at least one object in a manufacturing line. FIG. 9 illustrates a schematic diagram of the system 900 for simulating at least one object in a manufacturing line in accordance with embodiments of the present disclosure. As illustrated in FIG. 9, the system 900 may comprise a computer processor 910 coupled to a computer-readable memory unit 920, and the memory unit 920 comprises instructions 922. When executed by the computer processor 910, the instructions 922 may implement the method for simulating at least one object in a manufacturing line as described in the preceding paragraphs, and details will be omitted hereinafter.

In some embodiments of the present disclosure, a computer readable medium for simulating the at least one object in the manufacturing line is provided. The computer readable medium has instructions stored thereon, and the instructions, when executed on at least one processor, may cause at least one processor to perform the method for simulating at least one object in a manufacturing line as described in the preceding paragraphs, and details will be omitted hereinafter.

In some embodiments of the present disclosure, a manufacturing system is provided. The manufacturing system comprises: a manufacturing line, comprising: a conveyor; and a camera device configured to collect object data of at least one object placed on the conveyor; an apparatus for simulating the at least one object in the manufacturing line according to the present disclosure.

Generally, various embodiments of the present disclosure may be implemented in hardware or special purpose circuits, software, logic or any combination thereof Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 3. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for simulating at least one object in a manufacturing line, the at least one object being placed on a conveyor in the manufacturing line, the method comprising:
obtaining a position of one of the at least one object from object data collected by a camera device deployed in the manufacturing line;
determining a movement of the conveyor from a controller of the conveyor;
obtaining an object position of the object based on the determined position and an offset of the object caused by the movement of the conveyor; and
displaying a virtual representation of the object at the determined object position in a virtual environment.

2. The method of claim 1, further comprising:
determining the offset of the object, comprising:
determining a first time point at which the object data is collected by the camera device;
determining a second time point for displaying the virtual representation of the object; and
determining the offset based on a velocity of the movement of the conveyor and a time difference between the determined first and second time points.

3. The method of claim 2, further comprising:
adjusting the velocity of movement of the conveyor; and
displaying the virtual representation of the object comprising:
displaying the virtual representation of the object based on the adjusted velocity.

4. The method of claim 1, further comprising:
generating a position sequence based on object positions that are obtained during a predefined time duration, an object position comprised in the position sequence being associated with a time point within the predefined time duration.

5. The method of claim 4, further comprising:
displaying, in the virtual environment, a virtual representation of the object in response to a virtual representation of the conveyor reaching a position corresponding to an object position in the position sequence.

6. The method of claim 4, further comprising:
displaying, in the virtual environment, a virtual representation of the object at a time point associated with an object position in the position sequence.

7. The method of claim 1, further comprising:
determining an action of a robot system for processing the object, the robot system is to be deployed in the manufacturing line; and
displaying a virtual representation of the robot system based on the determined action.

8. The method of claim 7, wherein determining the action of the robot system comprises:
determining the action based on a processing pattern defining a manner for processing an object by the robot system.

9. The method of claim 1, wherein the camera device comprises a distance measurement camera, and the object data comprises a distance between the object and the camera device; and
determining the position comprises: determining the position based on the distance and a position of the camera device.

10. The method of claim 1, wherein the camera device comprises an image camera, and the object data comprises an image collected by the camera device, and
determining the position comprises: determining the position based on a position of the camera device and an image processing of the collect image.

11. An apparatus for simulating at least one object in a manufacturing line, the at least one object being placed on a conveyor in the manufacturing line, the apparatus comprising:
a position obtaining unit configured to obtain a position of one of the at least one object from object data collected by a camera device deployed in the manufacturing line;
a movement determining unit configured to determine a movement of the conveyor from a controller of the conveyor;
an object position obtaining unit configured to obtain an object position of the object based on the determined position and an offset of the object caused by the movement of the conveyor; and
a displaying unit configured to display a virtual representation of the object at the determined object position in a virtual environment.

12. The apparatus of claim 11, further comprising:
a determining unit configured to determine the offset of the object, comprising:
a first time unit configured to determine a first time point at which the object data is collected by the camera device;
a second time unit configured to determine a second time point for displaying the virtual representation of the object; and
an offset determining unit configured to determine the offset based on a velocity of the movement of the conveyor and a time difference between the determined first and second time points.

13. The apparatus of claim 12, further comprising:
an adjusting unit configured to adjust the velocity of movement of the conveyor; and
wherein the displaying unit is further configured to display the virtual representation of the object based on the adjusted velocity.

14. The apparatus of claim 11, further comprising:
a generating unit configured to generate a position sequence based on object positions that are obtained during a predefined time duration, an object position comprised in the position sequence being associated with a time point within the predefined time duration.

15. The apparatus of claim 14, further comprising:
an offline displaying unit configured to display, in the virtual environment, a virtual representation of the object in response to a virtual representation of the conveyor reaching a position corresponding to an object position in the position sequence.

16. The apparatus of claim 14, further comprising:
an offline displaying unit configured to display, in the virtual environment, a virtual representation of the object at a time point associated with an object position in the position sequence.

17. The apparatus of claim 11, further comprising:
an action determining unit configured to determine an action of a robot system for processing the object, the robot system is to be deployed in the manufacturing line; and
wherein the displaying unit is further configured to display a virtual representation of the robot system based on the determined action.

18. The apparatus of claim 17, wherein the action determining unit is further configured to determine the action based on a processing pattern defining a manner for processing an object by the robot system.

19. The apparatus of claim 11, wherein the camera device comprises a distance measurement camera, and the object data comprises a distance between the object and the camera device; and
the position determining unit is further configured to determine the position based on the distance and a position of the camera device.

20. The apparatus of claim 11, wherein the camera device comprises an image camera, and the object data comprises an image collected by the camera device, and
the position determining unit is further configured to determine the position based on a position of the camera device and an image processing of the collect image.

21. A system for simulating at least one object in a manufacturing line, the system comprising: a computer processor coupled to a computer-readable memory unit, the memory unit comprising instructions that when executed by the computer processor implements a method for simulating the at least one object, the at least one object being placed on a conveyor in the manufacturing line, the method comprising:
obtaining a position of one of the at least one object from object data collected by a camera device deployed in the manufacturing line;
determining a movement of the conveyor from a controller of the conveyor;
obtaining an object position of the object based on the determined position and an offset of the object caused by the movement of the conveyor; and
displaying a virtual representation of the object at the determined object position in a virtual environment.

22. A computer readable medium having instructions stored thereon, the instructions, when executed on at least one processor, cause the at least one processor to perform a method for simulating the at least one object, the at least one object being placed on a conveyor in the manufacturing line, the method comprising:
obtaining a position of one of the at least one object from object data collected by a camera device deployed in the manufacturing line;
determining a movement of the conveyor from a controller of the conveyor;
obtaining an object position of the object based on the determined position and an offset of the object caused by the movement of the conveyor; and
displaying a virtual representation of the object at the determined object position in a virtual environment.

23. A manufacturing system, comprising:
a manufacturing line, comprising:
a conveyor; and
a camera device configured to collect object data of at least one object placed on the conveyor;
an apparatus for simulating at least one object in the manufacturing line, the apparatus comprising:
a position obtaining unit configured to obtain a position of one of the at least one object from object data collected by a camera device deployed in the manufacturing line;
a movement determining unit configured to determine a movement of the conveyor from a controller of the conveyor;
an object position obtaining unit configured to obtain an object position of the object based on the determined position and an offset of the object caused by the movement of the conveyor; and
a displaying unit configured to display a virtual representation of the object at the determined object position in a virtual environment.
